(19) United States
(12) Patent Application Publication
(10) Pub. No.: US 2008/0044018 A1
(43) Pub. Date: Feb. 21, 2008

(54) Method and system to detect and prevent computer network intrusion

(76) Inventors: John P. Scrimsher, Palo Alto, CA (US); Daniel Madden, Palo Alto, CA (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/497,156

(22) Filed: Jul. 31, 2006

(51) Int. Cl. H04N 7/167

(52) U.S. Cl. 380/210

(57) ABSTRACT

A method and system for detecting and preventing network intrusion by generating an intrusion signature formatted using an intrusion signature template, the signature for use with an intrusion engine that allows adding new and/or modifying existing intrusion signatures. A packet analysis engine samples packets on the network, analyzes the sampled packets, and recognizes suspicious packets generated by malicious code. An intrusion signature generator then generates an intrusion signature using the template, and the signature is imported into an intrusion engine, which uses it to block the suspicious packets. The template can be provided by a network administrator, and the signature can be imported into the intrusion engine with or without human intervention.

### BACKGROUND

An intrusion detection system (IDS) generally detects unwanted communications on a computer network. An intrusion prevention system (IPS) generally controls access to a network and prevents access by unwanted users by blocking their communications. Current IDS and IPS solutions examine network communications and compare the communications with signatures of known unwanted communications to detect and block unwanted communications. Current solutions rely upon vendors to supply signatures to match network traffic and block the unwanted communications. New intrusion threats introduced to a network can go undetected if a signature recognizing that threat has not been provided by the vendor.

Some unwanted network intrusion events, for example viruses that spread via email, generate rapidly increasing amounts of network traffic. During an escalation, unwanted network traffic can have serious and even disastrous consequences. Waiting for a new signature from a vendor can add unacceptable wait times for resolution of the crisis.

Computer network communications typically comprise packets of information. A packet is a formatted block of information. A packet typically comprises three portions: a header, which marks the beginning of the packet; a data area, which contains the information to be carried in the packet; and a trailer, which marks the end of the packet. Each portion can also have other uses, such as addressing and error checking, and typically comprises of one or more fields supporting each function, such as port, IP address, protocol, data, and direction.

IDS/IPS solutions generally sample packets on the network, examine the contents of fields within each sampled packet, compare the contents with signatures to identify unwanted communications, and block the identified unwanted communications. IDS/IPS vendors generally have unique signature formats in relation to each other. For example, the open source IDS product Snort has a signature format different from the signature formats of the products of other vendors such as Sygate and ISS.

A network traffic analyzer or “packet sniffer” is a device or software program that samples, decodes, and logs network communications. Ethereal and TCPDump are both network traffic analyzers that collect information from network packets and display them to a person such as a network administrator for analysis. The drawback to such network analyzers is that they merely present the information to a person for review. They do not provide any information as to possible threats that may be associated with the traffic, nor do they suggest any detection signatures to use in an IDS/IPS solution.

### SUMMARY

A method and system are presented for detecting and thwarting network intrusion by recognizing a network communication threat for which there is no available signature in an IDS/IPS solution on the network. Communication packets are sampled and an intrusion threat is detected. A new intrusion signature is generated and imported into the intrusion engine of the IDS/IPS solution, which uses the new signature to thwart the intrusion.

The invention comprises a packet analysis engine which is used to sample packets on a system, analyze the sampled packets, recognize suspicious packets such as may be generated by malicious code, and generate data about the suspicious packets. The data about the suspicious packets is used to generate a signature that will detect and block similar traffic, and the signature is imported into the intrusion engine. The signature is formatted for use with the intrusion engine, in accordance with a provided template configured for use with the intrusion engine. Since the intrusion signature is formatted for use with whichever intrusion engine is on the network, the invention will work in virtually any customer environment. In an embodiment, traffic on both sending and receiving systems on the network is monitored, and packet information is correlated and used to generate the signature. In another embodiment, traffic of each system is monitored and analyzed, either individually or in conjunction with correlating traffic and analyzing traffic patterns of more than one system. The intrusion signature can be imported into the intrusion engine with or without human intervention.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention.

In the drawings:

FIG. 1 is a diagram of a network in accordance with the present invention.

FIG. 2 is a flow chart of a method for generating and using an intrusion signature in accordance with the present invention.

FIG. 3 is a block diagram of system to detect and prevent computer network intrusion in accordance with the present invention.

### DETAILED DESCRIPTION

Reference will now be made in detail to various embodiments of the present invention, an example of which is illustrated in the accompanying drawings. When used herein the phrase “intrusion engine” refers to an intrusion detection system (IDS) and/or intrusion prevention system (IPS). The phrase “intrusion signature” is a signature for use in an intrusion engine.

The invention comprises an IDS/IPS solution (intrusion engine) on a network that works in a conventional manner to detect and block undesirable network communications, such as caused by an intruder on the network. For example, a virus may be introduced onto a PC on the network, such as by an email attachment, thereby infecting the PC. The virus may then generate undesired network traffic, such as by sending copies of itself to other devices on the network, thereby infecting the other devices through the network. The intrusion engine samples packets on the network, examines their contents, and compares the packets' contents to signatures of known viruses. If the intrusion engine matches a packet to a signature, the packet is blocked.

However, packets not blocked by the intrusion engine may exhibit undesirable communication characteristics, such as would be caused by a new virus for which there is no signature. The invention detects and analyzes packets having these undesirable characteristics, and generates a new signature in accordance with a signature format template. The new signature is imported into the intrusion engine, which blocks packets exhibiting the undesirable communication characteristics. The new virus is thereby prevented from propagating via the network.

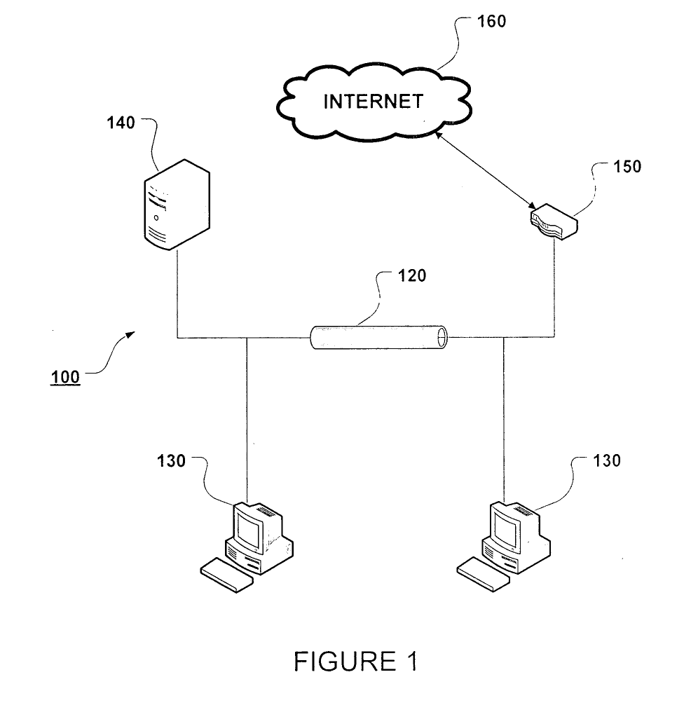

FIG. 1 shows a network 100 in accordance with one embodiment of the present invention. Network 100 comprises an Ethernet network 120 communicatively connecting PCs 130, server 140, and gateway 150. Gateway 150 provides access to the internet 160 for the other devices on the Ethernet network 120. In the exemplary embodiment shown, server 140 provides intrusion detection and prevention services to the devices on the network. Intrusion detection and prevention are provided by a conventional IDS/IPS solution (intrusion engine), combined with the present invention, which, as will be described more fully hereinafter, generates new signatures to block new threats.

Although an Ethernet network is illustrated, it is understood that any type of network may be used, using wired or wireless links, in any combination. Although PCs are illustrated, it is understood that the invention may be used in conjunction with any type of device susceptible to a communication threat, such as workstations or other types of computers or other network devices. Although server 140 is shown as a separate device, it is understood that server functionality, such as functionality provided by an intrusion engine and/or by the present invention, can be provided by one or more PCs 130 or other network devices such as a dedicated device, and can be distributed over more than one device. Although gateway 150 is shown as a separate device, it is understood that gateway functionality can be provided by a PC 130 or other network device, such as a router.

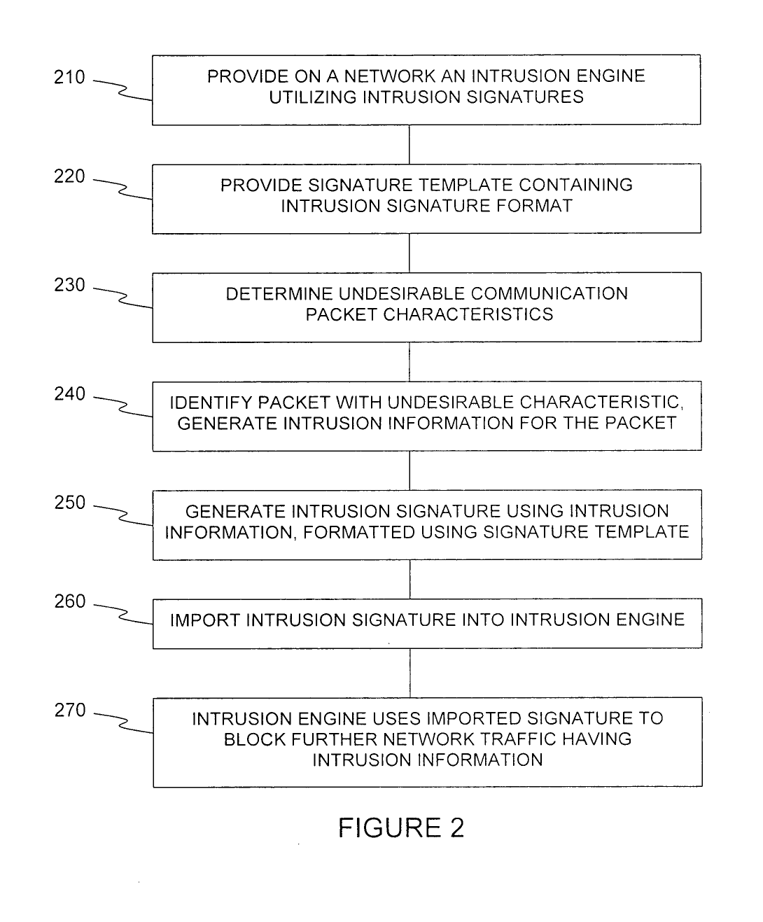

Using the network 120, PCs 130 and server 140 communicate, such as with each other, or with devices outside of the network via gateway 150 and internet 160. The communication is preferably accomplished using data packets. An intrusion engine preferably residing on the server 140 detects and prevents undesirable communications on the network using intrusion signatures. The signatures are typically provided by the IDS/IPS vendor, and the intrusion engine works by matching information from the packets with the signatures and blocking packets having characteristics matching any of the signatures. The present invention also preferably resides on server 140, and is able to generate a new signature for use by the intrusion engine to block a new threat. The intrusion engine imports the new signature, and uses it to detect and block undesirable communications for which a vendor supplied signature is not available, as illustrated in FIG. 2.

FIG. 2 is a block diagram showing the operation of the intrusion engine in cooperation with the present invention. Preferably, as hereinbefore described, the intrusion engine is provided on the network, step 210. The intrusion engine utilizes intrusion signatures to block undesirable network communications. The intrusion signatures conform to a particular format. Typically, the intrusion signatures provided by one vendor all conform to a particular format, and the signature format of one vendor is different from the signature format of a different vendor. In accordance with the present invention, a template is provided containing the intrusion signature format used by the intrusion engine on the network, step 220. The template is preferably provided by a network administrator.

One or more undesirable communication packet characteristics are determined, step 230. Undesirable characteristics indicating suspicious communications can be provided, for example, by a vendor or by the network administrator. In an embodiment, a packet analysis engine samples packets and determines one or more undesirable characteristics of network traffic, such as by monitoring the traffic on both a sending and a receiving system 130, and correlating their packet data. The packet analysis engine can be a device on the network, or can be implemented in software, such as software running on server 140 or other network device. The packet analysis engine samples some or all of the data packets on the network, examines the sampled packets, identifies packets having at least one undesirable characteristic, and generates information for the packet, herein designated intrusion information, step 240. The cause of the network communications exhibiting the undesirable characteristic is assumed to be malicious code running on at least one system on the network, such as a system infected by a virus. Such an infected system may be a network device, such as a server, router, or switch, or it may be a network connected PC, workstation, or other network device. The intrusion information is then used to generate the intrusion signature, step 250. The intrusion signature is generated in a format contained in a signature template, such as a template previously provided by a network administrator. The template is configured, such as by a network administrator, to conform to the signature format used by the intrusion engine. The generated intrusion signature is imported into the intrusion engine, step 260, which uses the signature to block packets having the intrusion information, step 270.

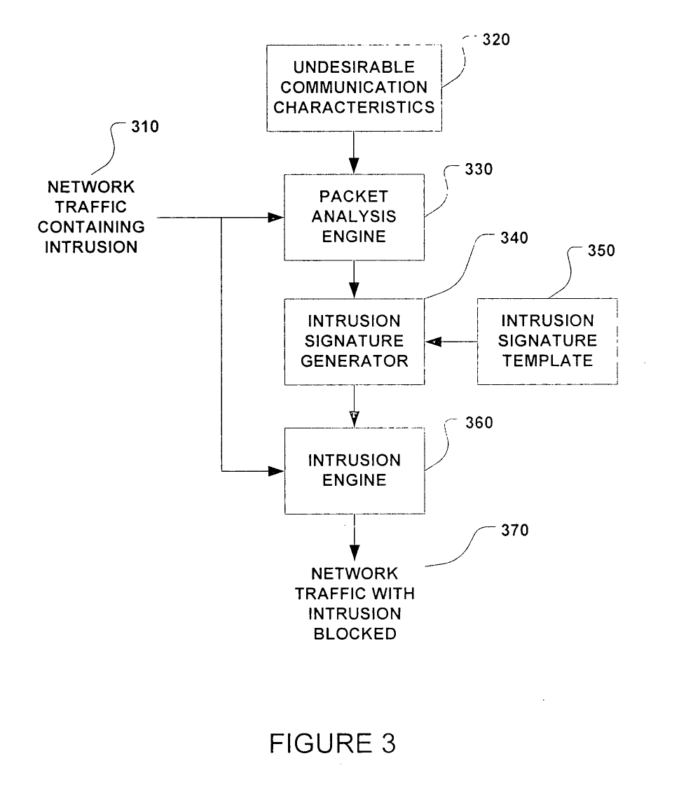

FIG. 3 is a block diagram of a system in accordance with the present invention. In FIG. 3, network traffic containing an intrusion, 310, exists on the network. The network traffic is sampled by the intrusion engine 360, which uses intrusion signatures to block unwanted communications, as hereinbefore described. If the intrusion conforms to a signature on intrusion engine 360, the network traffic containing the intrusion is blocked, 370.

The network traffic is also sampled by a packet analysis engine, 330, which detects packets having undesirable communication characteristics. The undesirable communication characteristics 320 can be supplied by the network administrator or a vendor and stored on the network, for example, in a file on server 140. In an embodiment, the undesirable communication characteristics are generated by the packet analysis engine 330, such as by monitoring the traffic on both a sending and a receiving system 130, and correlating traffic data to generate the undesirable characteristics. The packet analysis engine 330 examines packets having the undesirable communication characteristics, and generates intrusion information therefrom. The intrusion information is used by an intrusion signature generator 340 to generate an intrusion signature. The intrusion signature generator 340 generates the intrusion signature in accordance with an intrusion signature template 350. The intrusion signature is imported into the intrusion engine 360, which uses it to block packets having the generated intrusion information, 370.

The intrusion signature template specifies packet information such as port, IP address, protocol, data, and direction, and any other data included in communication packets that may be matched upon. In an embodiment, the packet analysis engine 330 monitors traffic on both a sending and a receiving system. The signature generator correlates the traffic, analyzes traffic patterns, and discovers suspicious activity. In another embodiment, the packet analysis engine 330 monitors and analyzes traffic from each system individually to discover suspicious activity, either alone or in conjunction with correlating traffic and analyzing traffic patterns of more than one system. When suspicious activity is discovered, packet analysis engine 330 generates intrusion information from the packets involved. The intrusion information is used by the intrusion signature generator 340 to generate the intrusion signature in accordance with the intrusion signature template 350.

Intrusion signature template 350 can be supplied by the network administrator, or it can be supplied by a vendor. By configuring the intrusion signature template 350 to work with whatever intrusion engine is on the network, the invention can work in virtually any customer environment. For example, if an old intrusion engine on the network is replaced with a new intrusion engine, the intrusion signature template 350 can be reconfigured so that the intrusion signature generator 340 will generate intrusion signatures in accordance with the signature format used by the new intrusion engine.

When a new intrusion signature is generated, it is imported into the intrusion engine 360 for blocking packets matching that signature. In an embodiment, the new signature can be imported by sending it to the network administrator using a conventional communication protocol such as SMTP, FTP, HTTP, or any other communication methods. After the administrator receives the signature, the administrator copies the signature into the intrusion engine 360 on the network. Alternatively, in another embodiment, the intrusion engine on the network directly imports the new signature or edits existing signatures without human intervention.

Various modifications and variations can be made in the present invention without departing from the spirit or scope of the invention. Thus, it is intended that the present invention cover the modifications and variations of this invention provided they come within the scope of the appended claims and their equivalents.

What is claimed is:

1. A method of detecting and preventing an intrusion on a network, comprising:
providing on the network an intrusion engine employing intrusion signatures having a signature format;
providing an intrusion signature template specifying the signature format;
identifying an intrusion;
generating an intrusion signature using information of the intrusion, formatted using the intrusion signature template; and
importing the intrusion signature into the intrusion engine,
whereby the intrusion engine uses the imported intrusion signature to detect and prevent the intrusion on the network.

2. The method of claim 1, wherein the identifying an intrusion step comprises:
determining an undesirable communication packet characteristic; and
identifying a communication packet having the undesirable characteristic.

3. The method of claim 1, wherein the information of the intrusion comprises at least one of PORT, IP ADDRESS, PROTOCOL, DATA, and DIRECTION.

4. The method of claim 1, wherein the intrusion signature template is provided by one of a network administrator and a vendor.

5. The method of claim 2, wherein the communication packet having the undesirable characteristic is identified by monitoring and correlating communication traffic on a sending and a receiving system.

6. The method of claim 1, wherein the intrusion signature is imported into the intrusion engine by a network administrator.

7. The method of claim 1, wherein the intrusion signature is imported into the intrusion engine without human intervention.

8. A system for detecting and preventing intrusion on a network using the method of claim 1, comprising:
an intrusion engine employing intrusion signatures having a signature format;
an intrusion signature template storing device for storing an intrusion signature template containing the signature format;
a packet analysis engine for identifying an intrusion,
an intrusion signature generator for generating an intrusion signature using information of the intrusion, formatted using the intrusion signature template; and
an intrusion signature importing mechanism for importing the intrusion signature into the intrusion engine.

9. The system of claim 8, further comprising:
an undesirable communication characteristic determining device for determining an undesirable communication packet characteristic and communicating the undesirable characteristic to the packet analysis engine;
whereby the packet analysis engine uses the undesirable characteristic to identify a communication packet having the undesirable characteristic thereby identifying the intrusion.
